(19) United States
(12) Patent Application Publication
(10) Pub. No.: US 2016/0153366 A1
(43) Pub. Date: Jun. 2, 2016

(54) Pump Arrangement And System For A Motor Vehicle

(71) Applicant: CONTINENTAL AUTOMOTIVE GMBH, Hannover (DE)

(72) Inventor: Ulf STEINERT, Maxhütte-Haidhof (DE)

(21) Appl. No.: 14/762,536

(22) PCT Filed: Aug. 11, 2014
(86) PCT No.: PCT/EP2014/067144

§ 371 Date: Jul. 22, 2015

(30) Foreign Application Priority Data
Aug. 23, 2013 (DE) 10 2013 216 817.9

(51) Int. Cl. F02D 1/06; F02M 55/02; F02M 61/00; F02M 59/02; F02M 59/46

(52) U.S. Cl. CPC F02D 1/06; F02M 59/025; F02M 59/46; F02M 61/00; F02M 55/025

(57) ABSTRACT

A pump arrangement for a motor vehicle includes a high pressure pump for delivering a fluid, which pump includes a fluid inlet, a fluid outlet, and a pressure chamber arranged hydraulically between the fluid inlet and the fluid outlet, a first pressure limiting valve having an inlet side coupled to the fluid outlet of the high pressure pump, and a second pressure limiting valve, wherein the two pressure limiting valves are connected hydraulically in parallel. Each pressure limiting valves has an opening pressure, wherein the opening pressure of the first pressure limiting valve is greater than the opening pressure of the second pressure limiting valve, and the opening pressure of the second pressure limiting valve is predefined based on an injector hydraulically coupled to the pump arrangement.

### CROSS-REFERENCE TO RELATED APPLICATIONS

This application is a U.S. National Stage Application of International Application No. PCT/EP2014/067144 filed Aug. 11, 2014, which designates the United States of America, and claims priority to DE Application No. 10 2013 216 817.9 filed Aug. 23, 2013, the contents of which are hereby incorporated by reference in their entirety.

### TECHNICAL FIELD

The invention relates to a pump arrangement for a motor vehicle. The invention furthermore relates to a system having a pump arrangement for a motor vehicle, in particular a fuel injection system.

### BACKGROUND

Pumps for fluid delivery, in particular a pump for fuel delivery for an injection system of a motor vehicle, usually have a pressure limiting valve. This valve is arranged on the high-pressure side of the pump. The valve is designed in such a way that, if a fault occurs, the maximum volume flow delivered by the high-pressure pump can flow back into the high-pressure piston chamber of the pump. The high-pressure system with the pump is thereby protected from impermissibly high pressures. Under normal operating conditions, the valve is closed. By virtue of the fact that the pressure limiting valve is usually coupled to the high-pressure piston chamber of the pump, the valve can only open during the suction phase of the pump. During the suction phase of the pump, the valve is hydraulically locked and cannot open.

### SUMMARY

One embodiment provides a pump arrangement for a motor vehicle, having: a high-pressure pump for delivering a fluid with a fluid inlet and a fluid outlet and a pressure chamber, which is arranged hydraulically between the fluid inlet and the fluid outlet, a first pressure limiting valve, which is coupled on the inlet side to the fluid outlet, a second pressure limiting valve, wherein the two pressure limiting valves are connected hydraulically in parallel, wherein the two pressure limiting valves each have an opening pressure, wherein the value of the opening pressure of the first pressure limiting valve is greater than the value of the opening pressure of the second pressure limiting valve, and wherein the value of the opening pressure of the second pressure limiting valve is predetermined depending on an injector, which can be coupled hydraulically to the pump arrangement.

In a further embodiment, the first pressure limiting valve is coupled hydraulically on the outlet side to the fluid inlet.

In a further embodiment, the second pressure limiting valve is coupled hydraulically on the outlet side to the pressure chamber.

In a further embodiment, the second pressure limiting valve is coupled hydraulically on the outlet side to the fluid inlet.

In a further embodiment, the second pressure limiting valve is coupled on the inlet side to the fluid outlet.

In a further embodiment, the second pressure limiting valve is coupled on the inlet side to the pressure chamber.

In a further embodiment, the second pressure limiting valve is designed as a passive pressure control valve with an opening pressure set to a fixed value.

In a further embodiment, the value of the opening pressure of the first pressure limiting valve is predetermined depending on a high-pressure manifold that can be coupled hydraulically between the fluid outlet and the injector.

In a further embodiment, the value of the opening pressure of the second pressure limiting valve is predetermined depending on the opening pressure of the injector.

Another embodiment provides a system comprising a pump arrangement as disclosed above, a high-pressure manifold, which is coupled hydraulically to the fluid outlet, and an injector for injecting the fluid into a combustion chamber of an internal combustion engine.

### BRIEF DESCRIPTION OF THE DRAWINGS

Example embodiments are explained in detail below with reference to the drawings, in which:

FIG. 1 shows a schematic illustration of a fuel injection system according to embodiments,

FIG. 2 shows a schematic illustration of a fuel injection system according to embodiments,

FIG. 3 shows a schematic illustration of a fuel injection system according to embodiments,

FIG. 4 shows a schematic detail view of a pump arrangement according to embodiments, and

FIG. 5 shows a schematic illustration of a pressure limiting valve according to embodiments.

### DETAILED DESCRIPTION

Embodiments of the invention provide a pump arrangement for a motor vehicle that provides reliable operation, and a system in a pump arrangement that provides reliable operation.

According to some embodiments, the pump arrangement has a high-pressure pump for delivering a fluid. The high-pressure pump has a fluid inlet and a fluid outlet and a pressure chamber, which is arranged hydraulically between the fluid inlet and the fluid outlet. The pump arrangement has a first pressure limiting valve, which is coupled on the inlet side to the fluid outlet. The pump arrangement has a second pressure limiting valve. The two pressure limiting valves are connected hydraulically in parallel. The two pressure limiting valves each have an opening pressure. The value of the opening pressure of the first pressure limiting valve is greater than the value of the opening pressure of the second pressure limiting valve. The pump arrangement can be coupled hydraulically to an injector. The value of the opening pressure of the second pressure limiting valve is predetermined depending on the injector.

The first pressure limiting valve may ensure that the maximum permissible pressure at the fluid outlet of the high-pressure pump is not exceeded. In order to avoid unnecessary opening of the first pressure limiting valve, the value of the opening pressure of the first pressure limiting valve is, in particular, greater than the system pressures which occur during normal operation in the pressure phase of the high-pressure pump. Thus, the first pressure limiting valve does not open during normal operation. In the case of a fault, the first pressure limiting valve provides protection from excessive pressures.

The second pressure control valve may ensure reliable opening of the injectors that can be coupled to the pump arrangement. The value of the opening pressure of the second pressure limiting valve is predetermined in such a way that the value of the opening pressure is below the maximum permissible pressure for the injector. The functioning of the injectors is thereby ensured. Here, the phrase “maximum permissible pressure for the injector” should be taken to mean the fluid pressure at which the injector can still just open reliably.

In particular, it is possible for the second pressure limiting valve to allow opening in each suction phase of the high-pressure pump in order to damp pressure pulsations which occur. It is thereby possible to protect the first pressure limiting valve from wear since the first pressure limiting valve remains closed in normal operation and opens only in the case of a fault.

According to other embodiments, the first pressure limiting valve is coupled hydraulically on the outlet side to the fluid inlet. This makes it possible to open the first pressure limiting valve in the case of a fault, even during the pressure phase of the high-pressure pump. A hydraulically closed pressure limiting valve can thus be avoided. The first pressure limiting valve is designed in such a way that the maximum volume flow of the high-pressure pump can be discharged through the first pressure limiting valve. The first pressure limiting valve is thus used to ensure that the maximum permissible pressure in the fluid outlet is not exceeded during the entire operating cycle of the high-pressure pump. In the case of a fault, it is possible for the entire maximum volume flow delivered by the high-pressure pump to be discharged back into the low-pressure region at the fluid inlet without a significant pressure rise. An impermissible pressure rise during the pressure phase is avoided.

According to embodiments, the second pressure limiting valve is coupled hydraulically on the outlet side to the pressure chamber.

Hydraulic closure of the second pressure limiting valve is thereby possible during the pressure phase of the high-pressure pump. A good pump efficiency is thus achieved since the entire volume of a pump cycle is delivered to the fluid outlet. By means of the first pressure limiting valve, the pump arrangement is always protected from impermissibly a high pressures.

According to other embodiments, the second pressure limiting valve is coupled hydraulically on the outlet side to the fluid inlet. According to embodiments, the second pressure limiting valve is coupled on the inlet side to the fluid outlet. Hydraulic communication between the fluid outlet and the fluid inlet is thus possible when the second pressure limiting valve is open. It is thus possible for the second pressure limiting valve to open during each pressure phase. Pressure pulsations at the fluid outlet are thus minimized. The dead volume within the high-pressure pump is reduced, thereby bringing about an increase in efficiency.

According to other embodiments, the second pressure limiting valve is coupled on the inlet side to the pressure chamber. Hydraulic communication between the pressure chamber and the fluid inlet is thus possible when the second pressure limiting valve is open. This makes it possible to minimize pressure pulsations in the pressure chamber and at the fluid outlet. The second pressure limiting valve can open in each pressure phase of the high-pressure pump.

According to other embodiments, the second pressure limiting valve is designed as a passive pressure control valve with an opening pressure set to a fixed value. For example, it is possible, by means of the second pressure limiting valve, to perform calibration of a pressure sensor at the fluid outlet. For this purpose, the system pressure is raised to the value of the opening pressure of the second pressure limiting valve, for example. By virtue of the fact that the opening pressure is set to a fixed value, the value of the opening pressure can be used as a reference.

According to other embodiments, the fluid outlet can be coupled to a high-pressure manifold. The injector can be coupled to the high-pressure manifold. In particular, the value of the opening pressure of the first pressure limiting valve can be predetermined depending on the high-pressure manifold. In particular, the value of the opening pressure is predetermined in such a way that a maximum predetermined pressure for the high-pressure manifold is not exceeded.

In particular, the value of the opening pressure of the second pressure limiting valve is predetermined depending on the lowest opening pressure of the injector. Reliable operation of the injector is thereby ensured.

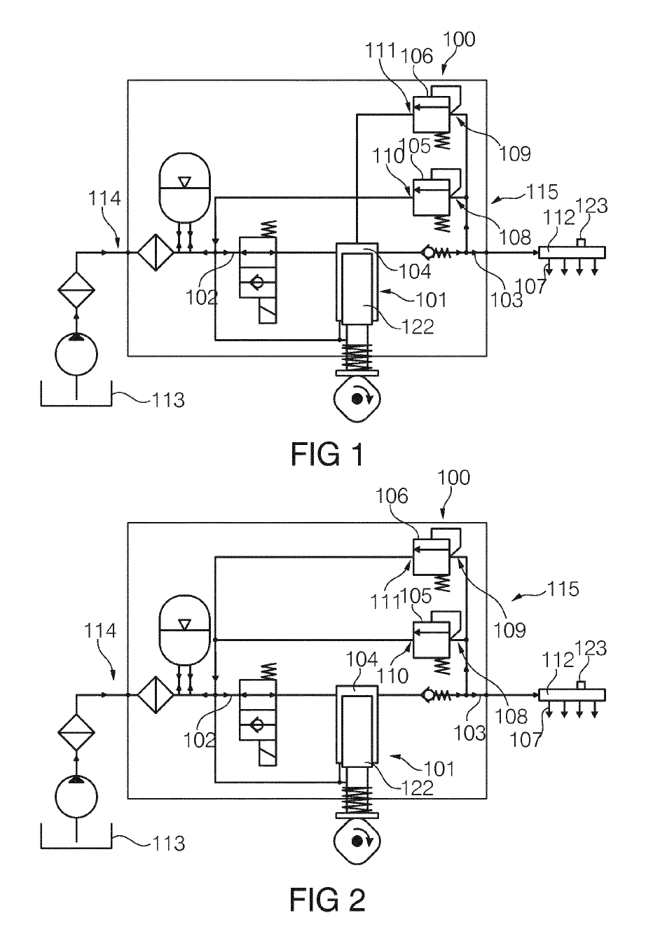

FIG. 1 shows a pump arrangement 100. In particular, the pump arrangement 100 is part of a fuel injection system of a motor vehicle. In particular, the fuel injection system is a “common rail” injection system. The pump arrangement 100 has a high-pressure pump 101 with a fluid inlet 102 and a fluid outlet 103.

A pressure chamber 104 is provided hydraulically between the fluid inlet 102 and the fluid outlet 103.

The fluid inlet 102 is arranged on a low-pressure side 114. In particular, the fluid inlet 102 is used for coupling the pressure chamber 104 to a fluid tank 113. The fluid outlet 103 is provided on a high-pressure side 115. In particular, the fluid outlet 103 is coupled to a high-pressure manifold 112. An injector 107 or a plurality of injectors 107 is coupled to the high-pressure manifold. The injectors are each designed to inject into an associated combustion chamber of an internal combustion engine during the operation of the motor vehicle. By means of the high-pressure pump 101, the fluid is pumped out of the fluid tank 113 and delivered under pressure into the high-pressure manifold 112. The pressures prevailing on the low-pressure side 114 during operation are below 5 bar, for example. The pressures prevailing on the high-pressure side 115 and, in particular, in the fuel manifold 112 are, in particular, over 300 bar, e.g. 350 bar or more.

In particular, the high-pressure pump 101 is a piston pump. A piston 122 is arranged in the pressure chamber 104. If the piston 121 moves along a longitudinal axis in such a way that the volume of the pressure chamber 104 increases, fluid is sucked into the pressure chamber 104 through the fluid inlet 102. This is the “suction phase” of the high-pressure pump 101. The piston 122 is then moved in the opposite direction, and the fluid is expelled from the pressure chamber 104 into the fluid outlet 103. This is the “pressure phase” of the high-pressure pump 101.

The pump arrangement 100 has a first pressure limiting valve 105. An inlet side 108 of the pressure limiting valve 105 is connected hydraulically to the fluid outlet 103. An outlet side 110 of the first pressure limiting valve 105 is connected hydraulically to the fluid inlet 102. The inlet side 108 of the first pressure limiting valve 105 is coupled hydraulically to the high-pressure side 115. The outlet side 110 of the first pressure limiting valve 105 is coupled hydraulically to the low-pressure side 114.

The first pressure limiting valve 105 has a predetermined opening pressure. The pressure limiting valve 105 blocks fluid flow through the pressure limiting valve 105 at pressures below the predetermined opening pressure. At pressures from the predetermined opening pressure, the pressure limiting valve 105 allows fluid flow through the pressure limiting valve 105. The value of the opening pressure of the first pressure limiting valve 105 is predetermined in such a way that a predetermined maximum pressure in the fluid outlet 103 and, in particular, in the high-pressure manifold 112 is not exceeded. The first pressure limiting valve 105 is closed during normal operation of the pump arrangement 100. If the predetermined value of the opening pressure on the inlet side 108 is reached and/or exceeded, the first pressure limiting valve 105 opens and allows fluid flow from the inlet side 108 to the outlet side 110. Thus, the pressure on the high-pressure side 115 is held within predetermined maximum limits. By virtue of the fact that the first pressure limiting valve 105 is connected hydraulically to the fluid inlet 102, it is possible for the first pressure limiting valve 105 to open both during the suction phase of the high-pressure pump 101 and during the pressure phase of the high-pressure pump 101. The first pressure limiting valve 105 is not hydraulically locked.

The pump arrangement 100 has a second pressure limiting valve 106. In particular, the second pressure limiting valve 106 is a passive pressure control valve. The second pressure limiting valve 106 has an opening pressure, the value of which is predetermined. The second pressure limiting valve 106 has a predetermined opening pressure. The pressure limiting valve 106 blocks fluid flow through the pressure limiting valve 106 at pressures below the predetermined opening pressure. At pressures from the predetermined opening pressure, the pressure limiting valve 106 allows fluid flow through the pressure limiting valve 106.

The value of the opening pressure of the second pressure limiting valve is less than the value of the opening pressure of the first pressure limiting valve. In the illustrative embodiments as shown in FIG. 1, the inlet side 109 of the second pressure limiting valve 106 is coupled hydraulically to the fluid outlet 103. An outlet side 111 of the second pressure limiting valve 106 is coupled hydraulically to the pressure chamber 104.

When the second pressure limiting valve 106 is open, fluid flow from the fluid outlet 103 into the pressure chamber 104 is thus possible. According to the illustrative embodiments as shown in FIG. 1, the second pressure limiting valve 106 is hydraulically locked during the pressure phase of the high-pressure pump 101. The second pressure limiting valve 106 can open only during the suction phase of the high-pressure pump 101 and is continuously closed during a pressure phase of the high-pressure pump 101.

In particular, the value of the opening pressure of the second pressure limiting valve is predetermined depending on the injector 107. The value of the opening pressure of the second pressure limiting valve 106 is predetermined depending on the maximum permissible injector opening pressure. Reliable operation of the injectors 107 is thereby made possible. In particular, the value of the opening pressure of the second pressure limiting valve 106 is below the maximum permissible pressure of the injector 107. Thus, the functioning of the injector 107 is ensured, i.e. reliable opening and injection of fluid into the combustion chamber. By virtue of the fact that the second pressure limiting valve 106 can open during the suction phase of the high-pressure pump 101, pressure pulsations in the fluid outlet 106 and in the high-pressure manifold 112 are reduced. By virtue of the fact that the second pressure limiting valve 106 can only open in the suction phase of the high-pressure pump 101, the efficiency of the pump arrangement 100 is good.

The use of a passive pressure control valve with a predetermined value for the opening pressure furthermore allows calibration of a pressure sensor 123. The pressure sensor 123 is designed to determine the fluid pressure in the high-pressure manifold 112.

The predetermined value of the opening pressure of the second pressure limiting valve 106 is, in particular, not changed during operation. This makes it possible to calibrate the pressure sensor 123 in relation to the fixed reference value of the opening pressure of the second pressure limiting valve 106. This is not possible with an actively controlled pressure control valve as used conventionally since the opening pressure in the case of an active valve can be adjusted to different values of the opening pressure by means of the applied control voltage and thus cannot form a fixed reference. The use of the passive second pressure control valve 106 is also less costly than an active pressure control valve as used conventionally.

The second pressure limiting valve 106 serves, on the one hand, as a pressure limiting valve in order to ensure the maximum permissible pressure at the injector 107. On the other hand, the pressure limiting valve 106 serves as a pressure control valve for minimizing pressure pulsations and, in particular, for performing calibration of the pressure sensor 123. In particular, the cross sections of the second pressure limiting valve 106 are predetermined in such a way that a maximum permissible surface pressure is not exceeded, despite high fluid pressures. In particular, the second pressure limiting valve 106 is of durable design.

The value of the opening pressure of the first pressure limiting valve 105 is so high that pressure pulsations during the operation of the pump arrangement 100 cannot lead to opening of the first pressure limiting valve 105. The outlet side 110 of the first pressure limiting valve 105 is connected to the low pressure region 114. As a result, a pressure reduction is possible independently of the suction phase and of the pressure phase of the high-pressure pump 101. Thus, a situation is avoided where the pressures in the line rise to a level higher than the value of the opening pressure of the first pressure limiting valve 105 during the pressure phase, something that can occur during the pressure phase with hydraulically locks pressure limiting valves. The predetermined cross sections of the first pressure limiting valve 105 are such that the maximum permissible system pressure cannot be exceeded at the maximum volume flow from the high-pressure pump 101 in the case of a fault. The first pressure limiting valve 105 is designed for higher volume flows than the second pressure limiting valve 106.

Thus, it is ensured that the maximum volume flow delivered by the high-pressure pump 101 can be discharged back into the low pressure region 114 without a significant pressure rise in the high-pressure manifold 112. An impermissible pressure rise in the pressure phase is avoided. In order to protect the first pressure limiting valve 105 from impermissible opening, the value of the opening pressure of the first pressure limiting valve 105 is set above the system pressures which occur in the pressure phase during normal operation. In order also to ensure reliable opening of the injectors 107 at the same time, the predetermined value of the second pressure limiting valve 106 is lower than the value of the opening pressure of the first pressure limiting valve 105. Thus, the functioning of the injectors 107 is ensured. The first pressure limiting valve 105 opens only in the case of a fault. Since the first pressure limiting valve 105 does not open during normal operation, wear on the first pressure limiting valve 105 is reduced. The first pressure limiting valve 105 and the second pressure limiting valve 106 are connected hydraulically in parallel on the inlet side.

FIG. 2 shows the pump arrangement 100 according to other embodiments. The pump arrangement 100 in FIG. 2 corresponds substantially to the embodiments of the pump arrangement 100 as explained in combination with FIG. 1. In contrast to the embodiments in FIG. 1, the outlet side 111 of the second pressure limiting valve 106 is connected hydraulically to the fluid inlet 102 .

The second pressure limiting valve 106 is connected hydraulically to the low-pressure side 114 on the outlet side. With the second pressure limiting valve 106 open, fluid flow from the fluid outlet 103 into the low-pressure region 114 is thus possible. The second pressure limiting valve 106 is not hydraulically closed during the pressure phase of the high-pressure pump 101. It is thus possible for the second pressure limiting valve 106 to open during the pressure phase of the high-pressure pump 101. As a result, pressure pulsations in the fluid outlet 103 and in the high-pressure manifold 112 are minimized by the second pressure limiting valve 106. The dead volume within the high-pressure pump 101 is reduced. This brings about an increase in the efficiency of the pump arrangement 100.

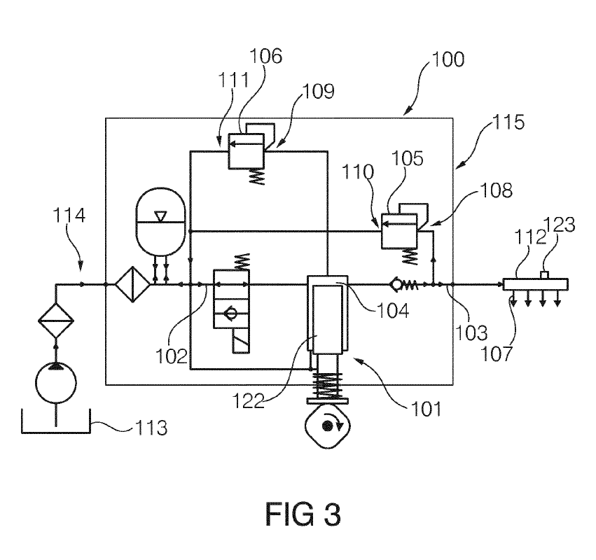

FIG. 3 shows the pump arrangement 100 according to other embodiments. The pump arrangement 100 according to FIG. 3 corresponds substantially to the embodiments as explained in combination with FIGS. 1 and 2. In contrast to the illustrative embodiments in FIGS. 1 and 2, the inlet side 109 of the second pressure limiting valve 106 is connected hydraulically to the pressure chamber 104. The outlet side 111 of the second pressure limiting valve 106 is connected hydraulically to the fluid inlet 102 or the low-pressure side 114.

With the second pressure limiting valve 106 open, fluid flow is allowed from the pressure chamber 104 into the fluid inlet 102. The second pressure limiting valve 106 opens during each pressure phase of the high-pressure pump 101. Pressure pulsations in the fluid outlet 103, in the high-pressure manifold 112 and in the pressure chamber 104 are in this way minimized.

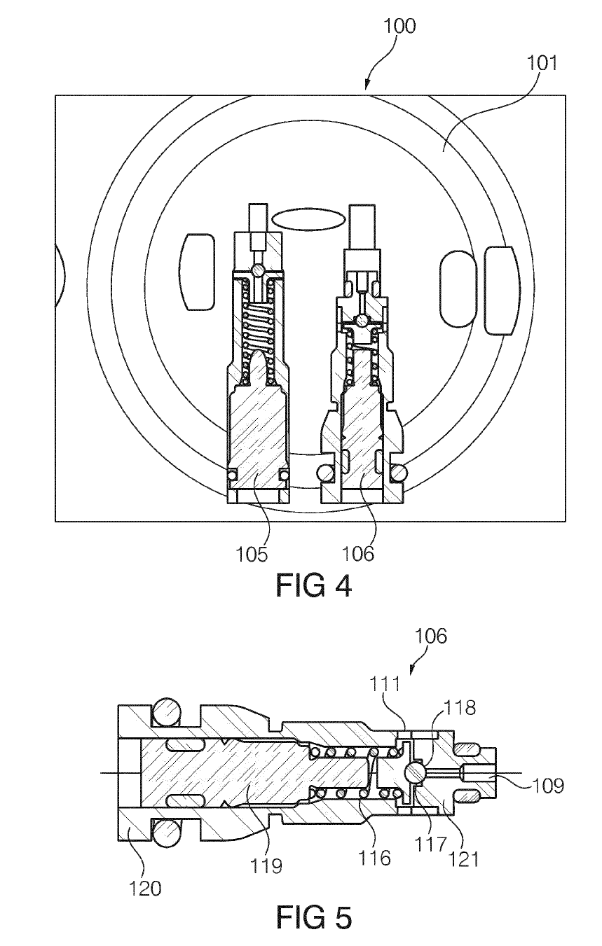

FIG. 4 shows the first pressure limiting valve 105 and the second pressure limiting valve 106, which are connected hydraulically in parallel. The set value of the opening pressure of the first pressure limiting valve 105 is greater than the value of the opening pressure of the second pressure limiting valve 106. The first pressure limiting valve 105 is designed for higher volume flows than the second pressure limiting valve 106. The predetermined value of the opening pressure and the predetermined value of the maximum volume flow of the first pressure limiting valve 105 are such that a maximum predetermined pressure in the high-pressure region 115 is never exceeded when the first pressure limiting valve 105 is functional. The value of the opening pressure and the value of the maximum volume flow of the second pressure limiting valve 106 are predetermined in such a way that reliable opening of the injectors 107 is ensured and pressure pulsations are damped.

FIG. 5 shows a schematic illustration of the second pressure limiting valve 106 according to one illustrative embodiment. The second pressure limiting valve 106 is designed differently in accordance with other embodiments.

The second pressure limiting valve 106 is what is referred to as a passive pressure control valve. The second pressure limiting valve 106 has a housing 120. In the housing, a spring 116 is preloaded between a holding element 119 and a sealing element 117.

The sealing element 117 is pushed against a sealing seat 118 by the spring. The sealing seat is arranged between the inlet 109 and the outlet 110. If the pressure on the inlet side 109 rises, the sealing element 117 is moved away from the sealing seat 118 against the spring force of the spring 116, and fluid flow is allowed from the inlet side 109 to the outlet side 110. A tapered cross section 121, which serves to limit through flow, is provided on the inlet side 109, for example. The value of the opening pressure of the second pressure limiting valve 106 is predetermined by means of the preload of the spring 116. The preload of the spring 116 is adjusted by a movement of the holding element 119 during the installation of the second pressure limiting valve 106 along a longitudinal axis 124. When the preload 116 reaches a predetermined value, the position of the holding element 119 relative to the housing 120 is fixed. Thus, the value of the opening pressure of the second pressure limiting valve 106 can be predetermined in a simple manner. By means of the limiting cross section 121, limitation of through flow when the valve is open is achieved. Moreover, a stroke stop for the sealing element 117 is achieved in a simple manner. According to embodiments, the second pressure limiting valve 106 is designed as a “cartridge” valve, i.e. as a self-contained component. According to embodiments, the second pressure limiting valve 106 is designed as a “plug-in” valve, i.e. as an inserted component. According to embodiments, the pressure limiting valve 106 is integrated directly into a housing of the pump 101.

By combining the first and the second pressure limiting valve 105, 106 in the pump arrangement 100, it is furthermore possible to reduce the pressure on the high-pressure side 115 during operation in comparison with conventional systems. It is thus possible to provide a low-cost O-ring seal between the high-pressure manifold 112 and the injector 107. It is thus possible to dispense with more expensive metal seals. By combining the two pressure limiting valves 105, 106, it is possible to enable low-emission operation of the internal combustion engine at a pressure of up to 350 bar on the high-pressure side 115. At the system pressure of up to 350 bar, the leaktightness of the connection between the high-pressure manifold 112 and the injector 107 is ensured by means of an O-ring.

1. A pump arrangement for a motor vehicle, having:
a high-pressure pump configured to deliver a fluid and comprising a fluid inlet, a fluid outlet, and a pressure chamber arranged hydraulically between the fluid inlet and the fluid outlet,
a first pressure limiting valve having an inlet side coupled to the fluid outlet of the high-pressure pump,
a second pressure limiting valve,
wherein the two pressure limiting valves are connected hydraulically in parallel,
wherein each of the two pressure limiting valves has an opening pressure,
wherein a value of the opening pressure of the first pressure limiting valve is greater than a value of the opening pressure of the second pressure limiting valve, and
wherein the value of the opening pressure of the second pressure limiting valve is predetermined based on a characteristic of an injector configured for hydraulic coupling to the pump arrangement.

2. The pump arrangement of claim 1, wherein the first pressure limiting valve includes an outlet side coupled hydraulically to the fluid inlet of the high-pressure pump.

3. The pump arrangement of claim 1, wherein the second pressure limiting valve includes an outlet side coupled hydraulically to the pressure chamber of the high-pressure pump.

4. The pump arrangement of claim 1, wherein the second pressure limiting valve includes an outlet side coupled hydraulically to the fluid inlet of the high-pressure pump.

5. The pump arrangement of claim 1, wherein the second pressure limiting valve includes an inlet side coupled to the fluid outlet of the high-pressure pump.

6. The pump arrangement of claim 1, wherein the second pressure limiting valve includes an inlet side coupled to the pressure chamber of the high-pressure pump.

7. The pump arrangement of claim 1, wherein the second pressure limiting valve comprises a passive pressure control valve with an opening pressure set to a fixed value.

8. The pump arrangement of claim 1, wherein the value of the opening pressure of the first pressure limiting valve is predetermined based on a high-pressure manifold configured for hydraulic coupling between the fluid outlet of the high-pressure pump and the injector.

9. The pump arrangement of claim 1, wherein the value of the opening pressure of the second pressure limiting valve is predetermined based on an opening pressure of the injector.

10. A system, comprising:
an injector for injecting fluid into a combustion chamber of an internal combustion engine,
a pump arrangement comprising:
a high-pressure pump configured to deliver the fluid and comprising a fluid inlet, a fluid outlet, and a pressure chamber arranged hydraulically between the fluid inlet and the fluid outlet,
a first pressure limiting valve having an inlet side coupled, to the fluid, outlet of the high-pressure pump,
a second, pressure limiting valve,
wherein the two pressure limiting valves are connected hydraulically in parallel
wherein each of the two pressure limiting valves has an opening pressure,
wherein a value of the opening pressure of the first pressure limiting valve is greater than a value of the opening pressure of the second pressure limiting valve, and
wherein the value of the opening pressure of the second pressure limiting valve is predetermined based on a characteristic of the injector, and
a high-pressure manifold hydraulically coupled to the fluid outlet of the high-pressure pump.

11. The system of claim 10, wherein the first pressure limiting valve includes an outlet side coupled hydraulically to the fluid inlet of the high-pressure pump.

12. The system of claim 10, wherein the second pressure limiting valve includes an outlet side coupled hydraulically to the pressure chamber of the high-pressure pump.

13. The system of claim 10, wherein the second pressure limiting valve includes an outlet side coupled hydraulically to the fluid inlet of the high-pressure pump.

14. The system of claim 10, wherein the second pressure limiting valve includes an inlet side coupled to the fluid outlet of the high-pressure pump.

15. The system of claim 10, wherein the second pressure limiting valve includes an inlet side coupled to the pressure chamber of the high-pressure pump.

16. The system of claim 10, wherein the second pressure limiting valve comprises a passive pressure control valve with an opening pressure set to a fixed value.

17. The system of claim 10, wherein the value of the opening pressure of the first pressure limiting valve is predetermined based on a high-pressure manifold configured for hydraulic coupling between the fluid outlet of the high-pressure pump and the injector.

18. The system of claim 10, wherein the value of the opening pressure of the second pressure limiting valve is predetermined based on an opening pressure of the injector.
